(19) United States
(12) Patent Application Publication
(10) Pub. No.: US 2026/0199976 A1
(43) Pub. Date: Jul. 16, 2026

(54) HYBRID SYSTEM FOR THERMAL ADDITIVE MANUFACTURING

(71) Applicant: Yuliya McAnany, Wayne, PA (US)

(72) Inventor: John D. McAnany, Wayne, PA (US)

(21) Appl. No.: 19/131,209

(22) PCT Filed: Nov. 20, 2023
(86) PCT No.: PCT/US2023/080619

§ 371 Date: May 19, 2025

Related U.S. Application Data
(60) Provisional application No. 63/426,719, filed on Nov. 19, 2022.

(51) Int. Cl. B22F 10/18; B22F 10/64; B22F 12/10; B28B 1/00; B33Y 10/00; B33Y 30/00; B33Y 40/20; C04B 33/04; C04B 33/13; C04B 33/32

(52) U.S. Cl. CPC B22F 10/18; B22F 10/64; B22F 12/10; B28B 1/001; B33Y 10/00; B33Y 30/00; B33Y 40/20; C04B 33/04; C04B 33/1305; C04B 33/32; B22F 2301/10; B22F 2998/10; C04B 2235/349; C04B 2235/6021; C04B 2235/6026

(57) ABSTRACT

Additive manufacturing systems and associated methods and build materials are described. The additive manufacturing systems herein include extrusion printheads, microheater printheads, and curable build materials. The extrusion printheads produce relatively low-resolution layers of uncured build material, and the microheater printheads cure portions of these low-resolution layers to produce high-resolution layers of cured build material.

### BACKGROUND

Additive manufacturing systems, also referred to as “3D printers”, generate three-dimensional objects by the addition of material. This technology differs from “subtractive manufacturing”, wherein material is removed to produce a desired object. The use of an additive manufacturing system often includes a digital model of the desired object. This object is often divided into many thin layers via a software tool. Each layer of the object may then be successively produced by the additive manufacturing system until a physical approximation of the digital model is completed.

Additive manufacturing systems do not rely on the use of molds or costly components designed to produce a specific object. Due to this, these systems are often useful for the production of prototypes or art objects, where few copies of a desired object will be produced. Some desired objects may have a geometry that is not possible to produce through subtractive manufacturing.

Fused Deposition Modeling (FDM) is an additive manufacturing technology that has become very popular. Within an FDM system, a printhead heats a solid build material to a temperature near the melting point of the material, and the material is extruded onto a build plate or a previously extruded layer. As the heated material is extruded, it quickly cools and becomes a solid shortly after contacting the build plate or previous layer. These systems commonly employ a thermoplastic build material. Current FDM systems are limited in their printing speed. They are also limited in their ability to utilize support material.

### SUMMARY OF THE INVENTION

Briefly, and in non-limiting terms, described herein are additive manufacturing systems incorporating extrusion printheads, microheater printheads, and curable build materials. Methods of using these systems and build materials useful for the additive manufacturing system embodiments herein are also described. Herein, extrusion printheads produce relatively low-resolution layers of uncured build material, and microheater printheads cure portions of these low-resolution layers to produce relatively high-resolution layers or voxels of cured build material.

Embodiments described herein offer advantages relative to current additive manufacturing systems. Some embodiments herein are able to use a single build material to act as both a support material and as the material of the desired object. The uncured build material, which acted as a support material during printing may be reused as build material in future printing. Additionally, the use of curable build material within the systems herein allows for the production of desired objects with high-resolution features, while also having high strength, toughness, and heat deflection.

Current additive manufacturing systems often require support structures or support material for the production of an object when portions of the desired object are not adequately supported in the z axis (vertically). Support structures often limit the feature resolution of desired objects and the surface finish achievable without post-processing steps (steps performed after printing is completed). In some embodiments described herein, the uncured build material acts as a support material that can be easily removed and thereby does not limit object resolution or surface finish. The use of a single build material for the desired object and the support material allows for an overall simpler additive manufacturing system and can decrease waste.

Current FDM systems must choose to prioritize printing speed or resolution, as an FDM system with a relatively small nozzle diameter will produce relatively high-resolution desired objects, at the cost of greater time needed for printing. Some embodiments described herein are able to utilize relatively low-resolution FDM-like nozzles that quickly extrude material, while still being able to produce high-resolution desired objects quickly due to a second, high-resolution microheater printhead. In other words, some embodiments described herein can be thought of as first quickly extruding a low-resolution layer of uncured build material and second producing a high-resolution layer of cured build material by the action of a microheater printhead.

### BRIEF DESCRIPTION OF THE DRAWINGS

FIG. 1 is a schematic diagram showing a front view of an embodiment of an additive manufacturing system.

FIG. 2 is a schematic diagram showing a side view of an embodiment of an additive manufacturing system.

FIG. 3 is a schematic diagram from a perspective view of an embodiment of an additive manufacturing system.

FIG. 4 illustrates a simplified process for the additive manufacture of a tree-shaped object, which could be performed by embodiments described herein.

### DETAILED DESCRIPTION OF THE INVENTION

The present disclosure provides systems and methods for additive manufacturing. The present disclosure also provides build materials that may be used with the systems and methods for additive manufacturing provided herein. Some build materials are inherently only useful within the systems and methods described herein. All references cited within this document are incorporated herein by reference in their entirety.

Embodiments, serving the purpose of examples, are described herein with sufficient detail to enable those of skill in the art to practice the invention. It should be understood that other embodiments may be realized and that various changes to the invention may be made without departing from the spirit and scope of the present invention. The detailed description of the embodiments of the present invention is not intended to limit the scope of the invention. The detailed description is presented to describe the features and characteristics of the present invention, to set forth the best mode of operation of the invention, and to sufficiently enable one skilled in the art to practice the invention. The scope of the present invention is to be defined only by the appended claims.

In the following description, for purposes of explanation, numerous specific details of certain embodiments are set forth. Reference in the specification to “an example”, “an embodiment”, or similar language means that a particular feature, structure, or characteristic described in connection with the example is included in at least that one embodiment, but not necessarily in other embodiments.

Within this specification, the singular forms “a,” “an,” and “the” include plural referents unless the context clearly dictates otherwise. Thus, for example, reference to “a polymer” includes one or more of such materials, and reference to “heating” includes reference to one or more of such steps.

As used herein, a plurality of items, structural elements, compositional elements, and/or materials may be presented in a common list for convenience. However, these lists should be construed as though each member of the list is individually identified as a separate and unique member. Thus, no individual member of such lists should be construed as a de facto equivalent of any other member of the same list solely based on their presentation in a common group without indications to the contrary.

As used herein, numerical values used in combination with “about” will be understood to describe all numerical values 10% above the numerical value to 10% below the value. For example, “a diameter of about 3 mm” will be understood to describe diameters of 2.7 to 3.3 mm, inclusive of all values within that range.

Concentrations, amounts, and other numerical data may be presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of 1 to 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than 4.5,” which should be interpreted to include all of the above-recited values and ranges. Further, such an interpretation should apply regardless of the breadth of the range or the characteristic being described.

### DEFINITIONS

As used herein, a “desired object” is a physical object that is produced by the action of an additive manufacturing system, and which is often based upon a digital object model. The desired object does not include any support material, although they may be physically linked at the time of printing. Support material is not intended to remain attached to the desired object. A desired object can be divided into smaller desired objects for easier production through the action of an additive manufacturing system. As used herein, a “rough object” includes a desired object along with any support material, uncured build material, and/or any other build material not part of the desired object that is physically attached to the desired object at the end of the printing process.

As used herein, “build material” refers to any material utilized within an additive manufacturing system that makes up at least a portion of the desired object or makes up at least a portion of support material.

A “curable build material” and variations of this term herein refer to a material wherein at least a portion of the material undergoes a change in its chemical structure or its material properties when heated to a sufficient temperature (thermally cured) and returned to an initial temperature. At least a portion of a curable build material may have any of the following properties after thermal curing, relative to uncured build material: a higher viscosity, a higher elastic modulus, a different bending modulus, a decreased solubility in a hydrophobic solvent, a decreased solubility in a hydrophilic solvent, a decreased solubility in water, a higher melting point, a higher glass transition temperature, an altered hygroscopicity, a higher heat deflection temperature, a higher tensile strength, an increased impact strength, or a greater number or degree of covalent crosslinks.

In some embodiments, curing of a build material describes a process producing cured build material with a decreased solubility in a hydrophobic solvent, relative to uncured build material. A hydrophobic solvent may be one or more of: acetone, acetonitrile, benzene, butanol, butyl acetate, carbon tetrachloride, chloroform, cyclohexane, dichloroethane, dichloromethane, dimethylformamide, dimethyl sulfoxide, dioxane, ethanol, ethyl acetate, diethyl ether, heptane, hexane, methanol, methyl ethyl ketone, pentane, propanol, diisopropyl ether, tetrahydrofuran, toluene, xylenes, pyridine, piperidine, n-methylpyrrolidone, and another similar solvent. In some embodiments, curing of a build material describes a process producing cured build material with a decreased solubility in a hydrophilic solvent, relative to uncured build material. A hydrophilic solvent may be one or more of acetic acid, water, water containing a surfactant, and another similar solvent. In some embodiments, curing of a build material describes a process producing cured build material with a higher melting temperature (Tₘ), relative to uncured build material. In some embodiments, curing of a build material describes a process producing cured build material with a higher glass transition temperature (T_{g}), relative to uncured build material. In some embodiments, curing of a build material describes a process producing cured build material with a higher Young's modulus, relative to uncured build material.

In some embodiments, curing of a build material describes at least sintering within the build material, and this sintering may take place between metallic and/or non-metallic materials. In some embodiments, curing a build material describes at least the build material partially melting or fully melting. In some embodiments, curing a build material describes at least the build material reaching a temperature greater than the melting temperature of all build material components. In some embodiments, curing a build material describes at least the build material reaching a temperature greater than the melting temperature of all build material components that make up greater than 5% of the total build material mass.

In some embodiments, curing of a build material describes a change in the chemical structure of at least one portion of the build material. In some embodiments, curing of a build material describes a change in the chemical structure of at least one portion of the build material, wherein additional covalent bonds have been formed. In some embodiments, curing of a build material described a change within the material without any additional covalent bonding present within the cured material. In some embodiments, curing increases the melting point and strength of a material without any additional covalent bonding present within the cured material.

A “printhead” may be defined herein as any component of an additive manufacturing system which interacts with or manipulates the build material for the purpose of producing a desired object.

As used herein, the term “printing” refers to any action performed by an additive manufacturing system that is performed in the course of producing a desired object. These actions may include: extrusion of build material, extrusion of support material, curing of build material, movement of build material, movement of motors to position printheads, producing a desired object, and other actions.

As used herein, the terms “build plate” and “print bed” are synonymous, indicating the surface within the additive manufacturing system that supports layers of build material. As used herein, the “build volume” or “build environment” describes the total volume in which build material can be deposited in order to produce a desired object, including the deposition of any support material and/or waste material.

As used herein, “metallic” is an adjective that describes a material being made up of a metal or metal alloy.

As used herein, a “polymer” and a “polymeric material” are synonymous. A polymer, a polymeric material, a curable build material, a “binder”, or a “binding material” referred to herein may be at least partially made up of at least one of: a polymeric material, an organic polymeric material, a thermoplastic, a biopolymer, polydimethylsiloxane, shellac, low-density polyethylene, high-density polyethylene, polypropylene, polystyrene, polytetrafluoroethylene, polyvinyl chloride, polychlorotrifluoroethylene, polylactic acid, an acrylic polymer, polymethyl methacrylate, polyether ether ketone (PEEK), a polyamide polymer, nylon 6, nylon 6-6, polybenzimidazole, a polycarbonate polymer, a polyether sulfone polymer, a polyoxymethylene (POM) polymer, a polyether ether ketone polymer, polyphenylene oxide, polyphenylene sulfide, polyvinylidene fluoride, a polyamide, a polycaprolactone, a polylactic acid, a poly(styrene-isoprene-styrene) (SIS), a poly(styrene-ethylene-butylene-styrene) (SEBS), a poly(styrene-butylene-styrene) (SBS), a high-impact polystyrene (HIPS), polystyrene, a thermoplastic polyurethane, a poly(acrylonitrile-butadiene-styrene) (ABS), a polymethylmethacrylate, a poly(vinylpyrrolidine-vinylacetate), a polyester (e.g., polyethylene terephthalate (PET), polyethylene naphthalate (PEN), polyethylene terephthalate glycol (PETG), and the like), a polycarbonate, a polyethersulfone, a polyether ether ketone, polyether aryl ketone, a polyetherimide, a polyethylene, a polyethylene oxide, a polyphenylene sulfide, a polypropylene, a polystyrene, a polyvinyl chloride, polyphenylene ethers (PPE), a poly(tetrafluoroethylene), a poly(vinylidene fluoride), a poly(vinylidene fluoride-hexafluoropropylene), a type of clay, a carbohydrate polymer, a polymer of one or more fatty acids, a natural wax, a cement, an inorganic material, a ceramic, a concrete, a cermet, a synthetic wax, paraffin wax, beeswax, soy wax, palm wax, gel wax, carnauba wax, shellac, a wax material similar to any in this list, a polymer known in research, a common commercial polymer, an engineering plastic, a copolymer of any polymer in this list, and a polymeric material similar to any within this list. In some embodiments, a binder surrounds particles and/or filaments of another material.

Used herein, the term “selective extrusion” refers to extruding build material in specific, non-random locations for the purpose of directly or indirectly producing a desired object. Used herein, the term “selective heating” refers to heating build material in specific, non-random locations for the purpose of directly or indirectly producing a desired object. Used herein, the term “selective curing” refers to curing build material in specific, non-random locations for the purpose of directly or indirectly producing a desired object.

In some embodiments, the present invention provides a system for additive manufacturing that includes at least two printheads, wherein at least one printhead performs at least the function of extruding build material, and at least one printhead is made up of at least a microheater array. In embodiments of this type, a printhead that performs at least the function of extruding build material will be referred to herein as an “extrusion printhead” and a printhead that is made up of at least a microheater array will be referred to herein as a “microheater printhead”.

### Power and Control

In some embodiments, the additive manufacturing system is made up of at least: a power source, a computer system that directs the functions of the system, printheads that place and cure the build material, a gantry and motor system that move the printheads, a structure that provides support for all system components, and a build material reservoir. The computer system may be internal or external to the additive manufacturing system. In some embodiments, the computer system is “wirelessly” attached to the additive manufacturing system through a technology such as WIFI, a Bluetooth connection, radio waves, infrared light signals, or another similar technology. In some embodiments, a touch screen and/or physical buttons are present on the additive manufacturing system itself to direct functions of the system.

In some embodiments, the additive manufacturing system can be connected to an external controller such as a personal computer, portable computer (for example a smartphone, tablet, or other similar device), or a specifically designed controller dedicated to operation of the printing system.

In some embodiments, there is provided a non-transitory computer-readable storage medium comprising a set of computer readable instructions stored thereon, which, when executed by a processor for an additive manufacturing system, cause the processor to carry out a number of instructions. In some embodiments, the instructions cause the processor to receive a digital object model. The digital object model defines the shape and nature of the three-dimensional object to be printed; in other words, the digital object model is made up of at least data defining an extent of an object in three-dimensions.

In some embodiments, software takes a digital object model and produces a plurality of layer definitions. Each layer definition may comprise a plurality of volumetric pixels, also referred to as voxels, which make up a layer of build material useful to constructing the desired object. Each layer definition may define extrusion voxel locations where build material must be deposited by the extrusion printhead, and it may define microheater printhead voxel locations where build material is to be cured. Each layer definition may also comprise more complex print data, such as a curing temperature profile for each voxel. In some embodiments, dissimilar curing temperatures for individual voxels produce a difference in the elastic modulus of the resultant voxel of cured build material.

### Structure and Movement

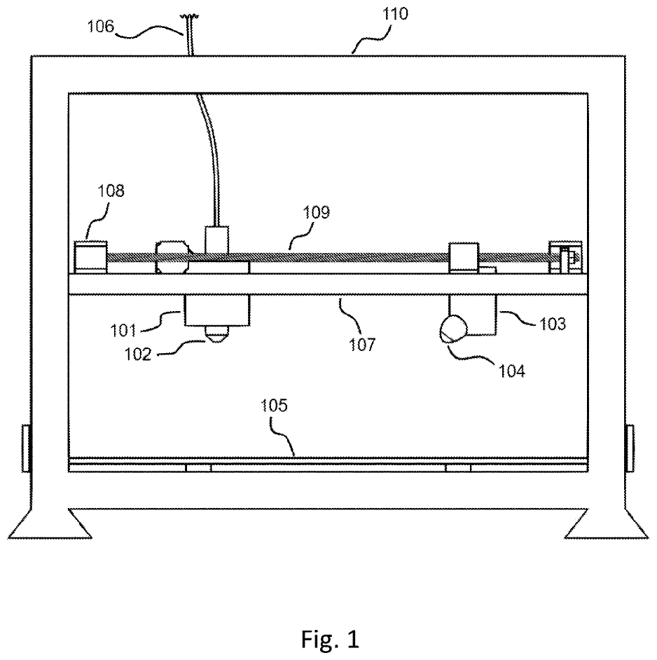

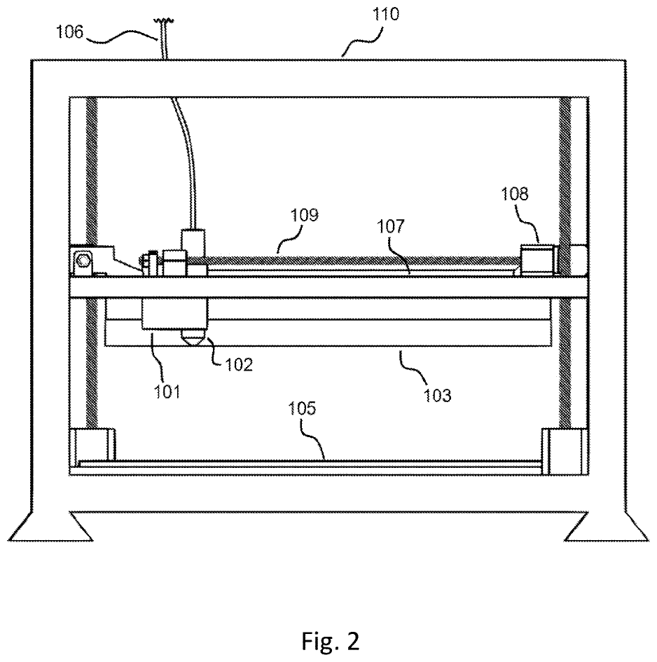

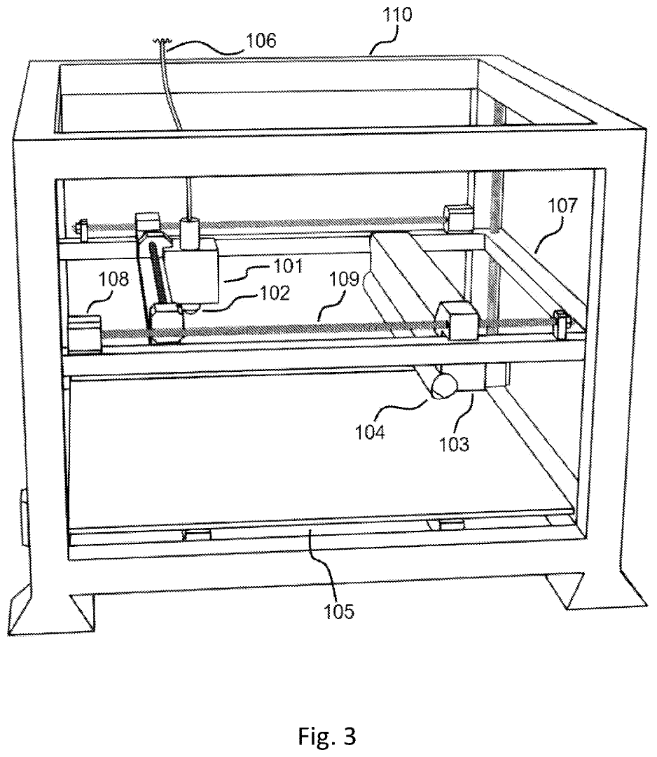

In the embodiments illustrated by FIGS. 1-3, a single extrusion printhead 101 and a single microheater printhead 103 are present within an additive manufacturing system. In some embodiments, an open cube-like structure 110 supports the additive manufacturing system. In the embodiments illustrated by FIGS. 1-3, both printheads are supported by a gantry 107 that allows simultaneous movement of the printheads along the z axis. Lead screws, for example 109, and stepper motors, for example 108, are shown to be involved in the movement of parts of the additive manufacturing system. Two stepper motors, and their associated lead screws, are responsible for movement of the extrusion printhead in the x axis and the y axis. A single stepper motor and its associated lead screw are responsible for movement of the microheater printhead. Two stepper motors, and their associated lead screws, are responsible for movement of the gantry that supports both printheads in the z axis. The extrusion printhead 101 takes in filamentous build material 106, heats the build material, and extrudes the build material through the extrusion nozzle 102. Extruded build material is deposited in a layer onto the print bed 105, or onto a previously extruded layer. As the microheater printhead passes over an extruded layer, a microheater array 104 selectively cures portions of the layer.

In the embodiments illustrated by FIGS. 1-3, a microheater printhead is capable of independent movement along the x axis. In these embodiments, an extrusion printhead is capable of independent movement along the x axis and the y axis, and a gantry supporting both printheads is moveable along the z-axis. The extrusion printhead is capable of being positioned along three axes in relation to the print bed, and the microheater printhead is capable of being positioned along two axes in relation to the print bed. It is to be understood that the axes of motion, in the illustrated embodiments, serve as examples.

It is to be understood that movement along two axes describes any type of movement within a two-dimensional plane, and movement along three axes describes any type of movement within three-dimensional space.

In some embodiments, the relative positioning of an extrusion printhead, in relation to the print bed, is achieved by movement of the print bed along three axes and movement of the extrusion printhead along zero axes. In other embodiments the extrusion printhead is moved along one axis and the print bed is moved along two axes. In other embodiments, the extrusion printhead is moved along two axes and the print bed is moved along a single axis. In other embodiments, the extrusion printhead is moved along three axes and the print bed is moved along zero axes.

In some embodiments, the relative positioning of a microheater printhead, in relation to the print bed, is achieved by movement of the print bed along two axes, and movement of the microheater printhead along zero axes. In other embodiments, the microheater printhead is moved along one axis, and the print bed is moved along one axis. In other embodiments, the microheater printhead is moved along two axes, and the print bed is moved along zero axes. In some embodiments, the microheater printhead performs multiple passes within the X-Y plane during curing of a single layer.

In some embodiments, the relative positioning of a microheater printhead, in relation to the print bed, is achieved by movement of the print bed along three axes and movement of the microheater printhead along zero axes. In other embodiments the microheater printhead is moved along one axis and the print bed is moved along two axes. In other embodiments, the microheater printhead is moved along two axes and the print bed is moved along a single axis. In other embodiments, the microheater printhead is moved along three axes and the print bed is moved along zero axes.

In some embodiments, the current position of at least one printhead or a print bed is determined by calculating the distance each of these components has moved from a known limit switch (also known as an endstop) location. In some embodiments, the current position of at least one printhead or a print bed is determined using a linear encoder, for example, a magnetic or optical linear encoder.

In some embodiments, movement of a gantry and/or individual printheads is preferably accomplished by high-resolution stepper motors. Various types of motors may be used for the movement of additive manufacturing system components in embodiments herein, including stepper motors, linear motors, servomotors, synchronous motors, D.C. motors, and fluid motors. In some embodiments, multiple types of motors are utilized within a single system to produce the desired motion. In some embodiments, stepper motor-driven screws are utilized to accomplish relative movement of printheads and/or a print bed. Some examples of the use of stepper motors within additive manufacturing systems are disclosed in U.S. Pat. No. 5,121,329, which is incorporated herein by reference, in its entirety.

In some embodiments, a layer of material is present on top of the print bed for the purpose of increasing adhesion between build material and the print bed. In some embodiments, this layer is chemically adhesive. In some embodiments, the layer has a high roughness and may be a type of sandpaper.

In some embodiments, layers of extruded build material are of uniform thickness. In some embodiments, layers of extruded build material vary in height, as desired for a particular desired object. Varying layer height may be useful to increase the z-axis resolution of a particular portion of a desired object.

In some embodiments, the printheads are capable of entirely independent movement without the use of a shared gantry system. Other systems of moving the printheads can also be used, such as those used in delta 3D printers, polar 3D printers, robotic arm-type 3D printers, and others. In some embodiments, more than one of each type of printhead can be used to increase printing speed, increase the build volume, or allow for the extrusion and/or curing of a larger number of materials.

In some embodiments, the print bed is capable of being precisely heated. In some embodiments, the print bed is capable of being heated by ceramic heating elements. In some embodiments, the print bed is capable of being heated using a closed-loop heating system. In some embodiments, an enclosure surrounds an additive manufacturing system. In some embodiments, the interior of an enclosure is capable of being heated to a desired temperature or temperature range. In some embodiments, a heating element is present within an additive manufacturing system for the purpose of heating the interior of an enclosure (this could alternatively be referred to as a chamber heater).

### General Printing Process

In some embodiments, the process for the production of a desired object is as follows in this paragraph. A first layer of uncured build material is selectively extruded onto the build plate. This is done by an extrusion nozzle passing over each area that requires build material and selectively extruding build material in those areas. The microheater printhead passes over all portions of this uncured build material that require curing. The individual heating elements within the microheater array are used to selectively cure portions of the build material. In some embodiments, this curing process may be performed on portions of a particular layer while the extrusion printhead is still extruding build material within the same layer. In some embodiments, the microheater printhead moves continuously over the build material. In some embodiments, the microheater printhead: moves to a portion of the build material requiring curing, stops moving while curing of the build material occurs, and begins moving again after the required curing has concluded. The first layer may take any shape dictated by a computer system. The second layer, and each subsequent layer, may take different shapes, as required by the cross section of each layer of the digital object model, including any desired support material. For the process wherein each layer is formed only in a horizontal plane consisting of the x axis and the y axis, at least one motor is selectively actuated after each layer is produced to raise the printheads along the z axis by a height necessary for the extrusion and possible curing of the following layer.

In some embodiments, non-planar printing is utilized. During non-planar printing, at least a single layer is formed wherein the extruded and/or cured build material does not lie within a single plane. In some embodiments, non-planar printing is utilized wherein at least one printhead moves in 3 dimensions relative to the print bed during the extrusion and/or curing of a single layer. In some embodiments, non-planar printing is utilized wherein it is not possible to distinguish where one layer ends and another begins, as at least one printhead is always or nearly always moving in 3 dimensions relative to the print bed. An example of this type of printing is FDM helical printing (sometimes referred to as vase mode).

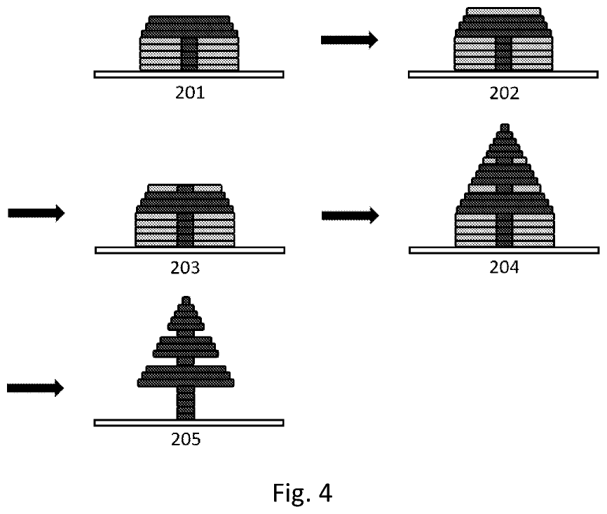

FIG. 4 illustrates the state of build material during printing within some additive manufacturing system embodiments described herein. The printing process begins with the selective deposition of uncured material 202 onto the print bed, or onto previously deposited layers of build material 201. The deposition is performed by an extrusion printhead. Selective curing of the uncured build material is then performed within the most recently deposited layer, if cured build material is desired in that particular layer. An entire extruded layer of build material may be cured, a portion of an extruded layer may be cured 203, or none of an extruded layer may be cured. This process is repeated until the entire desired object has been formed 204. Removal of uncured build material may be performed to produce a desired object free of uncured build material 205.

### Extrusion Printhead

In some embodiments, an additive manufacturing system is made up of at least a “extrusion printhead” that functions to extrude build material. The extrusion printhead is made up of at least at least an extrusion nozzle. In some embodiments, the extrusion printhead includes a volume for the purpose of heating build material. In some embodiments, the extrusion printhead includes metallic fins for the purpose of cooling a portion of the extrusion printhead. In some embodiments, the extrusion printhead includes at least one cooling fan for the purpose of cooling a portion of the extrusion printhead and/or for the purpose of cooling recently extruded build material. In some embodiments, the functions of an extrusion printhead are equivalent or similar to the functions of the printhead in a Fused Deposition Modeling (FDM) additive manufacturing system. The structure, function, and control of FMD printheads are described in U.S. Pat. No. 5,121,329 to Crump, the entirety of which is incorporated herein by reference, and other documents and materials.

In some embodiments, build material extrusion processes comprise heating a build material and extruding the build material through an extrusion nozzle. In some embodiments, build material is heated until it reaches a non-solid state before extrusion. A non-solid state may be a liquid state, a rubbery state, a state of viscous flow, or other similar states not defined as solid. In some embodiments, the build material is heated to a temperature equal to or greater than its glass transition temperature before extrusion through an extrusion nozzle. In some embodiments, the build material is heated to a temperature equal to or greater than its melting temperature before extrusion through an extrusion nozzle. In some embodiments, the build material is heated to a temperature wherein the build material appreciably decreases in viscosity before extrusion through an extrusion nozzle. In some embodiments, extruded build material cools to a temperature below its glass transition temperature before it is cured by the action of a microheater printhead. In some embodiments, extruded build material cools to a solid state before it is cured by the action of a microheater printhead. In some embodiments, extruded build material cools to a glassy state before it is cured by the action of a microheater printhead. In some embodiments, the maximum temperature reached by the build material before extrusion is controlled by a computer system and a heating element on or near an extrusion printhead. It should be understood that build material has been “extruded” when it has passed through an extrusion nozzle.

In some embodiments, a ceramic heating element is utilized to heat a build material before extrusion through an extrusion printhead. In some embodiments, a temperature sensor such as a thermistor or a thermocouple is present near a ceramic heating element as part of a closed-loop system for heating a build material. In some embodiments, a resistive heating element is utilized to heat build material before extrusion through an extrusion printhead. In some embodiments, a temperature sensor such as a thermistor or a thermocouple is present near a resistive heating element as part of a closed-loop system for heating the build material. In some embodiments, a temperature sensor such as a thermistor or a thermocouple is present close to a volume wherein build material is heated so that the temperature sensor can determine or approximate the temperature of the heated build material.

In some embodiments, a build material is heated at a temperature of 30-1500° C., 160-250° C., 180-200° C., 200-240° C., 500-1500° C., 650-1100° C., 30-160° C., or 45-85° C. before extrusion. In some embodiments, a build material is extruded at a temperature of 30-1500° C., 160-250° C., 180-200° C., 200-240° C., 500-1500° C., 650-1100° C., 30-160° C., or 45-85° C. In some embodiments, a build material comprising a polymeric material is heated at a temperature of 160-250° C., 180-200° C., or 200-240° C. before extrusion. In some embodiments, a build material comprising a metallic material is heated at a temperature of 500-1500° C. or 650-1100° C. before extrusion. In some embodiments, a build material comprising a wax material is heated at a temperature of 30-160° C. or 45-85° C. before extrusion.

In some embodiments, a build material is extruded through an extrusion nozzle at a temperature lower than the temperature required to instantaneously cure a build material. In some embodiments, the difference between the extrusion temperature of a build material and the curing temperature of the same build material is 5-20° C., 20-50° C., 50-100° C., 100-250° C., or 250-1000° C.

In some embodiments, the build material is preferably heated within the extrusion printhead. In other embodiments, the build material is heated near the extrusion printhead, and the build material is transferred to the extrusion printhead while in a non-solid state.

In some embodiments, a build material is provided in the form of a filament. In some embodiments, a reservoir of filamentous build material is present as a spool of filament. In some embodiments, a build material is present as powder, beads, particles, turnings, spheres, granules, or other low-aspect-ratio pieces of a material. In some embodiments, a reservoir of a low-aspect-ratio build material is present as a hopper containing the material.

In some embodiments, extruded material may be unintentionally extruded in such a way that build material is present above the intended maximum height of the current layer. In some embodiments, an extrusion nozzle may advantageously function to remove material unintentionally above the intended maximum height of the current layer. In some embodiments, as an extrusion nozzle moves over a specific layer it removes material above the intended maximum height of the current layer. In some embodiments, a blade, a heated blade, or another object is present for the purpose of removing material above the intended maximum height of the current layer.

### Build Material Movement

In some embodiments, a filamentous form of build material is utilized, and drive rollers are present for the purposes of forcing the filament into the extrusion printhead and forcing heated build material out of the extrusion nozzle. In some embodiments, these rollers are present within the extrusion printhead. In some embodiments, these rollers are present outside the extrusion printhead. In some embodiments, each roller is driven directly by a motor. In some embodiments, the movement of a plurality of rollers is linked by gears, a belt drive, or a chain drive. In some embodiments, rotational power is supplied to the drive rollers by a motor and gears, a belt drive, or a chain drive. These motors may be selected from any suitable type of motor, such as stepper motors, linear motors, servomotors, synchronous motors, D.C. motors, and fluid motors. In some embodiments, a high-resolution stepper motor is utilized for the purpose of delivering power to the drive rollers. In some embodiments, idler rollers are present on the opposite side of a filament relative to drive rollers. These idler rollers assist in gripping the filamentous build material.

In some embodiments, the rollers or gears that apply force to a filamentous build material are located close to or directly connected to an extrusion nozzle. This is often referred to as a “direct drive extruder”. In some embodiments, the rollers or gears that apply force to a filamentous build material are located far from the nozzle. This is often referred to as a Bowden extruder. In this type of extrusion printhead, a tube guides a filamentous build material from the rollers or gears into the nozzle. The tube is often referred to as a Bowden tube.

In some embodiments, a hopper containing low-aspect-ratio build material is connected to a volume for heating the build material to a non-solid state, and pressure is generated by at least one pump, at least one screw, or other means to extrude the heated build material through the extrusion nozzle. In some embodiments, a build material is heated far from an extrusion printhead, and heated non-solid build material is forced to move into the extrusion printhead. In some embodiments, the build material is heated far from the extrusion printhead, and heated liquid build material is forced to move into the extrusion printhead. In some embodiments, a non-solid or liquid build material is heated far from an extrusion printhead and is moved into the extrusion printhead by means of a fixed or variable displacement pump. In some embodiments, a single-screw extrusion printhead is present. In some embodiments, a dual-screw extrusion printhead is present.

### Addition of Colorant

In some embodiments, a volume is present wherein colorant is added to a build material before it is extruded. In some embodiments, a volume is present wherein colorant is added to a build material after the build material has been heated and before it exits an extrusion nozzle. In some embodiments, a volume is present with a geometry intended to cause mixing of a colorant with a build material as heated build material is forced through the volume. The addition of colorants within the context of some types of extrusion nozzles is described in U.S. Pat. No. 9,283,714, which is incorporated herein by reference, in its entirety.

In some embodiments, an additive manufacturing system is made up of at least an extrusion printhead, a microheater printhead, and a colorant printhead, wherein the colorant printhead is capable of selectively adding at least one of a dye, a pigment, and a colorant to at least a potion of a layer of build material some time before a subsequent layer of build material is added. In some embodiments, the colorant printhead is a continuous inkjet (CIJ) printhead, a drop-on-demand printhead, and/or a piezo drop-on-demand (DOD) printhead.

### Extrusion Nozzle Size

In some embodiments, the internal diameter of an extrusion nozzle, at the point where build material exits the extrusion nozzle, is 0.05 mm to 100 mm, 0.10 mm to 1.40 mm, 0.20 mm to 0.40 mm, 0.40 mm to 0.80 mm, 0.80 mm to 1.00 mm, or greater than 1.00 mm. In some embodiments, the internal diameter of an extrusion nozzle, at the point where build material exits the extrusion nozzle, is about 0.20 mm, about 0.30 mm, about 0.35 mm, or about 0.40 mm. In some embodiments, the internal diameter of an extrusion nozzle, at the point where build material exits the extrusion nozzle, is 0.20 mm, 0.30 mm, 0.35 mm, 0.40 mm, 0.60 mm, 0.80 mm, 1.00 mm, or 1.20 mm. In some embodiments, the size of the extrusion nozzle, at the point where build material exits the extrusion nozzle, is larger than the center-to-center distance (pitch) of heating elements of a microheater printhead within the same additive manufacturing system.

### Microheater Printhead

A microheater printhead is made up of at least a plurality of heating elements. A plurality of heating elements is also referred to herein as a “microheater array”. In some embodiments, the microheater printhead additionally includes a physical linkage between the heating elements and other portions of the structure of an additive manufacturing system. In some embodiments, an additive manufacturing system is made up of at least at least an extrusion printhead and a microheater printhead. In some embodiments, a microheater printhead includes a physical linkage between the heating elements and a gantry, wherein the gantry supports both the microheater printhead and an extrusion printhead. In some embodiments, a microheater printhead additionally includes a mechanism to position the heating elements parallel to the plane of the print bed. In some embodiments, a microheater printhead includes a mechanism to position the microheater array along the z axis relative to an extrusion printhead. In some embodiments, the microheater printhead and the extrusion printhead are physically linked, and they are not capable of independent movement within the system. In some embodiments, the microheater printhead and the extrusion printhead are positioned such that the extrusion nozzle is surrounded by a 2-dimensional microheater array. In some embodiments, at least one cooling fan and/or at least one thermally conductive component is/are present within an additive manufacturing system are present to cool build material.

Linear heating element arrays comprising 600 heating elements per inch are often used in thermal printers, and are often referred to as receipt or label printers. Linear heating element arrays are often produced with linear array lengths of 303 mm (KYOCERA Corporation, “Thermal Printheads”, January 2018, incorporated herein by reference, in its entirety). The disclosure of U.S. Pat. No. 9,421,715, patented Aug. 23, 2016, to Hartmann et al. is incorporated herein in its entirety. These commercially available printheads often cause a heated material to reach 250° C. (R. Uyhan, J.A. King-Hele “Modelling of thermal printhers” Applied Mathematical Modelling, 2008, 32:405-416, incorporated herein by reference, in its entirety).

In some embodiments, at least one microheater printhead is preset within an additive manufacturing system. In some embodiments, the microheater printhead is made up of at least a plurality of resistive heating elements. In some embodiments, each resistive heating element of a microheater printhead is individually addressable. In some embodiments, a single microheater printhead and a single extrusion printhead are present within an additive manufacturing system. In some embodiments, a single extrusion printhead and multiple microheater printheads are present in an additive manufacturing system. In other embodiments, a single microheater printhead and multiple extrusion printheads are present in an additive manufacturing system. In some embodiments, multiple microheater printheads and multiple extrusion printheads are present in an additive manufacturing system.

In some embodiments, resistive heating elements of a microheater printhead are wire heating elements. In some embodiments, resistive heating elements of a microheater printhead are metal or metal alloy heating elements. In some embodiments, resistive heating elements of a microheater printhead are ceramic heating elements. In some embodiments, resistive heating elements of a microheater printhead are semiconductor heating elements. In some embodiments, resistive heating elements of a microheater printhead are thick film heating elements. In some embodiments, resistive heating elements of a microheater printhead are polymeric heating elements. In some embodiments, resistive heating elements of a microheater printhead are composite heating elements. In some embodiments, resistive heating elements of a microheater printhead comprise titanium, platinum, molybdenum, tungsten, polysilicon, or molybdenum disilicide.

In some embodiments, molybdenum disilicide heating elements are present in a microheater printhead and operate at a maximum temperature of 1000-2000° C. In some embodiments, platinum heating elements are present in a microheater printhead and operate at a maximum temperature of up to 800° C. In some embodiments, tungsten heating elements are present in a microheater printhead and operate at a maximum temperature of up to 1200° C.

In some embodiments, resistive heating elements within a microheater printhead are arranged in a 1-dimensional array (in other words, in a line or in a linear array). In some embodiments, multiple resistive heating elements within a microheater printhead are arranged in a 2-dimensional array (in other words, arranged within a plane). In some embodiments, resistive heating elements within a microheater printhead are arranged in a non-standard arrangement that is not a 1-dimensional array or a 2-dimensional array. For example, a specific non-standard array arrangement appears linear when viewed from the top and bottom but appears curved when viewed from the side.

In some embodiments, the feature size of cured build material within a desired object and/or support material, produced by the action of a microheater printhead, is smaller than or equal to the center-to-center distance (pitch) of heating elements of the microheater printhead. In some embodiments, the feature size of cured build material, produced by the action of a microheater printhead, is not equal in both axes of a layer of build material. In some embodiments, the feature size of cured build material is dictated along a first axis by the pitch of heating elements within a microheater printhead, and is dictated along a second axis by the speed at which the microheater printhead moves over the build material.

In some embodiments, a 1-dimensional array of heating elements, within a microheater printhead, is made up of at least: 20-29,000; 100-15,000; 350-7,500; 1,000-2,000; 2,000-3,000; 3,000-4,000; or about 1,920 heating elements. In some embodiments, a 2-dimensional array of heating elements, within a microheater printhead, is made up of at least: 10,000-33,200,000; 100,000-200,000: 200,000-500,000: 500,000-1,100,000: 1,100,000-2,100,000: 2,100,000-8,300,000; 8,300,000-33,200,000; or 33,200,000-133,000,000 heating elements.

In some embodiments, each individual heating element of a microheater printhead has an area equivalent to a circle with a diameter of 0.001-2 mm, 0.001-0.005 mm, 0.005-0.010 mm, 0.010-0.050 mm, 0.050-0.100 mm, 0.100-0.200 mm, 0.200-0.300 mm, 0.300-0.400 mm, or greater than 0.400 mm.

In some embodiments, heating elements of a microheater printhead are fabricated using at least microelectromechanical systems (MEMS) fabrication techniques. In some embodiments, heating elements of a microheater printhead are fabricated using at least lithographic fabrication techniques. In some embodiments, heating elements of a microheater printhead are fabricated using at least semiconductor lithography fabrication techniques. In some embodiments, heating elements of a microheater printhead are built on a substrate. This substrate may be glass, silicon, sapphire, langasite, or alumina. Glass may be beneficial due to its low thermal conductivity. Silicon may also be used despite its high thermal conductivity due to its ease of processing with MEMS fabrication. Silicon underneath a microheater array can be etched away to leave the microheater on a thin membrane of dielectric material to increase power efficiency. The process of fabricating a microheater array using MEMS techniques is to grow a dielectric layer, then use photolithography to pattern the substrate, and then deposit the microheater material and conductive leads using sputtering or e-beam evaporation.

In some embodiments, a microheater printhead is capable of positioning the heating element surfaces a distance from the build material that is intended to be cured. This distance will be referred to as the microheater printhead “vertical offset”. In some embodiments, the vertical offset is 0 mm, and the heating element surfaces will contact the build material to be cured. In some embodiments, the vertical offset is 1-10 μm, 10-50 μm, 50-100 μm, 100-300 μm, or greater than 300 μm. In some embodiments, a microheater printhead includes a mechanism to adjust the vertical offset. In some embodiments, a microheater printhead includes a mechanism to adjust the vertical offset manually. In some embodiments, a microheater printhead includes a mechanism to adjust the vertical offset using a computer-controlled motor.

In some embodiments, the microheater printhead vertical offset is filled with air, helium, carbon dioxide, argon, nitrogen, or a plasma. The thermal conductivity of a gas or plasma filling a space between the heating elements of a microheater printhead and the build material is an important variable, and preferably the gas or plasma has a high thermal conductivity.

In some embodiments, a protective sheet is present between a heating element array of an additive manufacturing system and the build material. In some embodiments, a protective sheet is in direct contact with both the heating element array and the build material. In some embodiments there is a space between at least one of: the protective sheet and the build material, or the protective sheet and the heating element array. It is preferable for a protective sheet to have a high thermal conductivity. In some embodiments, the protective sheet is stationary relative to the heating element array during the majority of the time spent printing a desired object. In some embodiments, the protective sheet is stationary relative to the build plate during the majority of the time spent printing a desired object. In some embodiments, the protective sheet is moved relative to the heating element array to provide a clean and/or non-degraded portion of the protective sheet in contact with the heating element array.

The temperature of each heating element, within a microheater printhead, must be controlled with adequate accuracy and precision. In some embodiments, one or more temperature sensing components are present within a microheater printhead to monitor the temperature of the heating elements. In some embodiments, one temperature sensing component is present for the purpose of monitoring each individual heating element of a microheater printhead. In some embodiments, temperature sensing components within a microheater printhead are thermistors. In other embodiments, temperature sensing components within a microheater printhead are thermocouples. In some embodiments, heating elements of a microheater printhead are controlled in an open-loop manner. In some embodiments, heating elements of a microheater printhead are controlled in a closed-loop manner. In some embodiments, heating elements of a microheater printhead are controlled using a PID control system. In some embodiments, heating elements of a microheater printhead are controlled in a closed-loop manner, wherein the temperature of a heating element is determined using the temperature-resistance relationship of the heating element itself.

In some embodiments, the following curing steps are performed: a microheater printhead is positioned over extruded build material, individual heating elements positioned proximal to voxels of build material that need to be cured are heated to a desired temperature, the individual heating elements are held at this temperature for a desired length of time, and all of the heating elements are allowed to cool. In some embodiments, the following curing steps are performed: a microheater printhead is positioned over extruded build material, individual heating elements positioned proximal to voxels of build material that need to be cured are heated to a desired temperature, and all of the heating elements are allowed to cool. In some embodiments, the following curing steps are performed: the microheater printhead is constantly moving along one axis over extruded build material, individual heating elements proximal to voxels of build material that need to be cured are heated to a desired temperature, the individual heating elements are held at this temperature for a desired length of time, and all of the heating elements are allowed to cool. In some embodiments, the following curing steps are performed: the microheater printhead is constantly moving along one axis over extruded build material, individual heating elements proximal to voxels of build material that need to be cured are heated to a desired temperature, and all of the heating elements are allowed to cool.

In some embodiments, heating elements within a microheater printhead reach a temperature of 40-1850° C., 160-500° C., 160-250° C., 250-500° C., 350-450° C., 500-1850° C., 650-1100° C., 850-1400° C., 900-1100° C., or 1100-1400° C. to cause the curing of build material. In some embodiments, heating elements within a microheater printhead reach a temperature of 40-1850° C., 160-500° C., 160-250° C., 250-500° C., 350-450° C., 500-1850° C., 650-1100° C., 850-1400° C., 900-1100° C., or 1100-1400° C. to cause the curing of build material comprising a polymeric build material.

In some embodiments, an individual heating element of the microheater printhead is capable of reaching the desired temperature needed for build material curing within 0 -2000 ms, 0-1 ms, 1-5 ms, 5-10 ms, 10-20 ms, 20-50 ms, or 50-300 ms, or greater than 300 ms.

### Build Materials

Additive manufacturing system embodiments described herein may use multiple materials for the purpose of producing desired objects. In some embodiments, build materials useful herein are able to be cured at a temperature equal to or greater than the temperature at which they are extruded by an extrusion printhead. In some embodiments, a single type of build material is utilized. In other embodiments, multiple types of build materials are utilized.

As used herein, “metallic” is an adjective that describes a material being made up of a metal or metal alloy. In the embodiments herein, a metallic particle or a metallic material is made up of at least one material of the following list: a metal of 99 % purity or greater, a metal alloy, aluminum, aluminum bronze, brass, admiralty brass, chromium, copper, gold, Inconel™, iron, cast iron, lead, molybdenum, nickel, platinum, silver, sterling silver, steel, carbon steel, stainless steel, titanium, tungsten, zinc, tin, babbitt, beryllium, beryllium copper, bismuth, cadmium, cobalt, magnesium, manganese, manganese bronze, mercury, palladium, rhodium, silicon, or similar metals or alloys.

In some embodiments, the curing temperature of a curable build material is greater than the extrusion temperature of the same material. In some embodiments, the curing temperature of a curable build material is greater than the extrusion temperature of the same material by: 10° C., 25° C., 60° C., 90° C., 120° C., or 150° C. In some embodiments, the curable build material is at least partially made up of an interpenetrating network before, during, and/or after curing.

In some embodiments, a curable build material is capable of acting as support material in its uncured state. In some embodiments, support structures attached to a desired object after printing are partially or wholly made up of uncured build material. In some embodiments, uncured build material is only present between a cured portion of a support structure and a cured portion of a desired object. U.S. Pat. No. 5,503,785, patented Apr. 2, 1996, to Crump et al. is incorporated herein in its entirety.

In some embodiments, a curable build material is still capable of additional curing after printing is completed, or is in other words, partially cured. In some embodiments, a curable build material is further cured after printing is completed. In some embodiments, a curable build material is further cured after printing is completed, involving the use of an oven.

In some embodiments, a curable build material is made up of particles or filaments of a curable build material within a binder material. In some embodiments, the melting point of the particles or filaments within a binder material is at least 0-15° C., 15-30° C., 30-60° C., 60-100° C., 150-300° C., or greater than 300° C. different than the melting point of the binder material. In some embodiments, the particles or filament within a binder material are curable, whereas the binder material is not curable. In some embodiments, the curable build material has a higher melting temperature than the binder material. In some embodiments a curable build material is supplied to an additive manufacturing system as pieces or particles of low-aspect ratio material, and may be held in a hopper. In some embodiments a curable build material is supplied to an additive manufacturing system as a filament, and may be held on a spool.

In some embodiments, a curable build material is made up of at least a first polymer and a second polymer, wherein the second polymer is able to crosslink, or covalently bond to the first polymer when heated. In some embodiments a curable build material is made up of at least a first polymer, a second polymer, and a thermal radical initiator, wherein the second polymer is able to crosslink, or covalently bond to the first polymer when heated. In some embodiments, the first and/or second polymer of this paragraph bears at least one of: an electrophile moiety, a pendant electrophile moiety, a pendant carboxylic acid, a pendant ester moiety, a nucleophile moiety, a pendant nucleophile moiety, a pendant alcohol moiety, a pendant primary amine moiety, an isocyanate moiety, an olefin moiety, a thioester moiety, a silicone moiety, a urethane moiety, phenol moiety, a cyanate moiety, and an epoxy moiety. In some embodiments, a curable build material made up of a single polymeric material, optionally containing a thermal radical initiator, is able to undergo crosslinking or additional crosslinking with heating. In some embodiments, curing of a build material involves at least one of a transesterification reaction, an esterification reaction, and a condensation reaction. In some embodiments, curing of a build material involves at least crosslinking of one or more fatty acids or fatty acid derivatives. In some embodiments, a curable build material made up of a single polymeric material bears at least one of: an electrophile moiety, a pendant electrophile moiety, a pendant carboxylic acid, a pendant ester moiety, a nucleophile moiety, a pendant nucleophile moiety, a pendant alcohol moiety, a pendant primary amine moiety, an isocyanate moiety, a thioester moiety, an olefin moiety, a silicone moiety, a urethane moiety, phenol moiety, a cyanate moiety, and an epoxy moiety.

In some embodiments, a curable build material is made up of at least polymethyl methacrylate and polyethylene glycol. In some embodiments, a curable build material is made up of at least polydimethylsiloxane (PDMS). In some embodiments, a curable build material is made up of at least polymethyl methacrylate and methyl methacrylate monomer.

In some embodiments, a curable build material is made up of at least ABS, PC, nylon, PEEK, or POM particles or filaments within a PLA or polycaprolactone binder material. In some embodiments, a filamentous curable build material may be made up of at least PolyEther Ether Ketone (PEEK) particles within a binder made up of at least polylactic acid. Before, during, and after extrusion through an additive manufacturing system described herein, the PEEK particles within this curable build material substantially remain as unconnected particles. After thermal curing, by the action of the microheater printhead within this same additive manufacturing system, the PEEK material has at least partially melted and is now connected. This causes the cured build material to have a greater melting point and greater strength than the uncured build material, even though no additional crosslinking is present.

In some embodiments, a curable build material is at least partially made up of a thermal radical initiator that generates free radicals when heated. In some embodiments, a curable build material is at least partially made up of a thermal initiator that produces additional crosslinking within the curable build material.

In some embodiments, a curable build material is at least made up of particles having a shell material with a first melting temperature, and wherein these particles possess a core material with a second melting point, and wherein these particles are present within a binder material having a third melting point. In some embodiments, the first melting temperature is higher than the other two. Heating of this type of curable build material to a sufficient temperature causes the shell material to rupture and causes the core material to interact with the binder material. In some embodiments, the interaction of the core material and the binder material causes curing to occur. In some embodiments, the interaction of the core material and the binder material with heating causes curing to occur.

In some embodiments, a curable build material is a plastisol, being made up of polymer particles and a plasticizer. In some embodiments, a curable build material is made up of at least a plasticizer and a polymer. In some embodiments, a curable build material is made up of at least plasticizer and polyvinyl chloride.

In some embodiments, a curable build material is a type of ceramic and/or clay, and a hopper is used to store the ceramic or clay before extrusion. In some embodiments, the clay build material contains additives, such as colorants and/or lubricants. In some embodiments, a curable build material is a type of cermet, concrete, and/or cermet.

In some embodiments, a curable build material is a composite of an inorganic material and a binding material. In some embodiments, a curable build material is a composite of a binder and particles of a clay. In some embodiments, a curable build material is a composite of a binder and particles of a clay, formed into a filament. In some embodiments, a curable clay and binder composite material is a filament and is made up of at least a clay core surrounded by a sheath of binding material. In other embodiments, a curable clay and binder composite material is a filament, wherein particles of a clay are surrounded by binding material. In some embodiments, a curable clay and binder composite material is a filament, wherein binding material is surrounded by particles of a clay.

In some embodiments of a curable clay and binder composite material, the mass of the clay makes up 1-99% of the total mass of the composite material. In some embodiments of a curable clay and binder composite material, the mass of the clay makes up 10-80% of the total mass of the composite material. In some embodiments of a curable clay and binder composite material, the mass of the clay makes up 20-60% of the total mass of the composite material. In some embodiments of a curable clay and binder composite material, the mass of the clay makes up less than 50% of the total mass of the composite material.

In some embodiments, a curable build material is a composite of a binding material and ceramic particles. In some embodiments, a curable build material is a composite of a binder and ceramic particles, formed into a filament. In some embodiments, a curable ceramic and binder composite material is a filament, and is made up of at least a ceramic core surrounded by a sheath of binding material. In other embodiments, a curable ceramic and binder composite material is a filament, wherein ceramic particles are surrounded by binding material. In some embodiments, a curable ceramic and binder composite material is a filament, wherein binding material is surrounded by ceramic particles. Multiple examples of ceramic and binder composite materials are currently offered for sale. One of these commercially available materials is described in the product description of LAYCERAMIC (Kai Parthy, CC-Products, “LAYCERAMIC sinter-able filament for printing”, June 2017). This product description is incorporated by reference herein, in its entirety.

In some embodiments of a curable ceramic and binder composite material, the mass of the ceramic makes up 1-99% of the total mass of the composite material. In some embodiments of a curable ceramic and binder composite material, the mass of the ceramic makes up 10-80% of the total mass of the composite material. In some embodiments of a curable ceramic and binder composite material, the mass of the ceramic makes up 20-60% of the total mass of the composite material. In some embodiments of a curable ceramic and binder composite material, the mass of the ceramic makes up less than 50% of the total mass of the composite material.

In some embodiments, a curable build material is a composite of a binding material and metallic particles. In some embodiments, a curable build material is a composite of an organic binder and metallic particles. In some embodiments, a curable build material is a composite of an organic binder and metallic particles, formed into a filament. In some embodiments, a curable metallic particle and binder composite material is a filament and is made up of at least a metallic core surrounded by a sheath of binding material. In other embodiments, a curable metallic particle and binder composite material is a filament, wherein metallic particles are surrounded by binding material. In some embodiments, a curable metallic particle and binder composite material is a filament, wherein binding material is surrounded by metallic particles.

In some embodiments utilizing a metallic particle and binder composite material, the mass of the metallic particles makes up 1-99% of the total mass of the composite material. In some embodiments of the metallic particle and binder composite material, the mass of the metallic particles makes up 1-60% of the total mass of the composite material. In some embodiments of the metallic particle and binder composite material, the mass of the metallic particles makes up 60-99% of the total mass of the composite material. In some embodiments of the metallic particle and binder composite material, the mass of the metallic particles makes up 70-95% of the total mass of the composite material. In some embodiments of the metallic particle and binder composite material, the mass of the metallic particles makes up 10-40% of the total mass of the composite material. In some embodiments of the metallic particle and binder composite material, the mass of the metallic particles makes up 20-35% of the total mass of the composite material. Multiple examples of a metallic particle and binder composite materials are currently offered for sale, and one is described in the product description of Filamet^{TM} (The Virtual Foundry “How To 3d Print Metal” Accessed Nov. 17, 2022, incorporated by reference herein, in its entirety).

In some embodiments, a curable build material may be filled with a non-curable material to change the properties of the overall build material. In some embodiments, a curable build material may be filled with glass particles and/or fibers. In some embodiments, a curable build material may be filled with carbon fibers. In some embodiments, a curable build material may be filled with fibers and/or particles of an inorganic material. In some embodiments, a curable build material may be filled with fibers and/or particles of a ceramic material. In some embodiments, a curable build material is food safe, biocompatible, and/or capable of use in cell culture.

In some embodiments, an additive manufacturing system incorporates a multi-material system, wherein the multi-material system is capable of altering a build material being extruded during printing, without the interaction of a human user. In some embodiments, a multi-material system operates by switching from extrusion of a first build material to extrusion of a second build material, with additional switches being possible. In some embodiments, a multi-material system operates by adjusting the ratio of two or more build materials that are being extruded simultaneously.

In some embodiments, an additive manufacturing system herein is capable of being used in a sub-optimal manner by using a non-curable material, wherein a thermal printhead is used to increase the adhesion between layers of extruded, non-curable build material. In some embodiments, an additive manufacturing system herein is capable of being used in a sub-optimal manner by using a non-curable material and intentionally not using a thermal printhead, so that the system operates in a manner similar to an FDM additive manufacturing system.

### Processing After Printing

In some embodiments, after the printheads have completed their actions for the production of a desired object or a rough object, additional processing steps are performed. These additional processing steps may be performed while the desired object is still, in some manner, tethered to the print bed or after it has been removed from the print bed. In some embodiments, processing after printing serves to remove uncured build material from the cured build material. In some embodiments, processing after printing serves to remove uncured build material by mechanical agitation, such as scrapping or brushing away the uncured build material. A solvent described within this paragraph may be a single solvent or a solution of multiple miscible solvents selected from the following list: water, acetic acid, acetone, acetonitrile, benzene, butanol, butyl acetate, carbon tetrachloride, chloroform, cyclohexane, dichloroethane, dichloromethane, dimethylformamide, dimethyl sulfoxide, dioxane, ethanol, ethyl acetate, diethyl ether, heptane, hexane, methanol, methyl ethyl ketone, pentane, propanol, diisopropyl ether, tetrahydrofuran, toluene, xylenes, pyridine, piperidine, n-methylpyrrolidone, and/or another similar solvent. In some embodiments, processing after printing includes removing uncured build material by dissolving or solubilizing the uncured build material using a solvent. In some embodiments, uncured build material is dissolved or solubilized using a solvent that is at a temperature of greater than 22° C. In some embodiments, the uncured build material is dissolved or solubilized using a solvent that is at a temperature of greater than 40° C. In some embodiments, after uncured build material is dissolved or solubilized, the uncured build material is precipitated or otherwise is returned to a solid and non-soluble state by cooling the solvent. In some embodiments, a surfactant is used to dissolve or solubilize uncured build material. Any of the processing after printing procedures within this paragraph may be combined.

### ENUMERATED EMBODIMENTS

1) A system for additive manufacturing comprising at least one microheater array, at least one extrusion nozzle, and a curable build material, wherein the microheater array comprises at least 20 heating elements.
2) The system of embodiment 1, wherein the curable build material is a type of clay.
3) The system of any one of embodiments 1-2, wherein the curable build material comprises particles of clay within a binder, and wherein the binder has a melting temperature below the temperature needed for sintering or curing of the clay particles.
4) The system of embodiment 1, wherein the curable build material comprises particles of a higher melting temperature polymer present within a polymer of a lower melting temperature.
5) The system of embodiment 4, wherein the melting temperatures of the two polymers are separated by at least 20 degrees Celsius.
6) The system of embodiment 4-5, wherein the glass transition temperatures of the two polymers are separated by at least 20 degrees Celsius.
7) The system of embodiment 1, wherein the curable build material comprises metallic particles within a binder, and wherein the binder has a lower melting temperature than the metallic particles.
8) The system of embodiment 1, wherein the curable build material comprises at least one of polymer and at least one wax.
9) The system of embodiment 1, wherein the curable build material comprises particles of an inorganic material within a binder, and wherein the binder has a lower melting temperature than the curing or sintering temperature of the inorganic material.
10) The system of any one of embodiments 1-9, wherein the microheater array is a linear array.
11) The system of any one of embodiments 1-9, wherein the microheater array is a 2-dimensional array.
12) The system of any one of embodiments 1-9, wherein the microheater array is circularly-shaped.
13) The system of any one of embodiments 1-9, wherein the microheater array is square-shaped rectangularly-shaped.
14) The system of any one of embodiments 1-13, wherein one microheater array and one extrusion nozzle are present.
15) The system of any one of embodiments 11-14, wherein the microheater array elements surround the extrusion nozzle.
16) The system of any one of embodiments 1-15, wherein a build plate moves along 0 axes and at least one printhead moves along 3 axes.
17) The system of any one of embodiments 1-15, wherein a build plate moves along 1 axis and at least one printhead moves along 2 axes.
18) The system of any one of embodiments 1-15, wherein a protective sheet is present between the build material and the microheater array.
19) The system of any one of embodiments 1-18, wherein, as the microheater array cures build material, a vertical offset is present between the heating element surface of the microheater array and the build material.
20) The system of embodiment 19, wherein the vertical offset is filled with at least one of air, argon, nitrogen, carbon dioxide, an inert gas, a nonflammable gas, and a plasma.
21) The system of any one of embodiments 1-20, wherein a blade, a doctor blade, a protrusion, or a tool is present to make level extruded build material that has not yet been cured by the thermal printhead.
22) A system for additive manufacturing comprising at least one thermal array, having a plurality of heating elements, and at least one extrusion nozzle.
23) A system for additive manufacturing comprising at least one microheater array and a curable build material, wherein the microheater array comprises at least 20 heating elements.
24) A method of producing a three-dimensional object comprising:
   a) selectively extruding build material through an extrusion nozzle; and
   b) selectively curing build material by heating caused by a heating array.
25) A material for use within an additive manufacturing system comprising a material wherein:
   a) the material is capable of being extruded through an extrusion nozzle at an extrusion temperature; and
   b) the material is capable of being cured through the action of a heating array, and wherein curing takes place at a curing temperature that is higher than the extrusion temperature.
26) The material of embodiment 25, wherein the material further comprises particles or filaments of a curable build material are present within a surrounding binder material.
27) The material of embodiment 25, wherein the material further comprises particles or filaments of a polymeric material are present within a binder.

### EXAMPLES

### Example 1: An Additive Manufacturing System Using a Ceramic Composite Material

A single extrusion printhead and a single microheater printhead are present within an additive manufacturing system. The exterior support structure of the system is in the shape of a cube. The print bed is within the cube at the bottom and is not capable of movement along any axis. The print bed is 220 mm wide and 130 mm deep, with a useable printing area of 200 mm by 106 mm. The print bed is capable of being heated by a closed-loop system using ceramic heating elements. The two printheads are attached to a square-shaped gantry on the interior of the cube. This gantry is capable of vertical movement (movement in the z axis). The z axis height of the microheater printhead, independent of the extrusion printhead, is manually adjustable. The extrusion printhead is capable of movement, independent from the other printhead, along the x and y axes. The microheater printhead is capable of movement, independent from the other printhead, along only the y axis. The extrusion printhead is capable of movement in all 3 axes, and the microheater printhead is capable of movement along 2 axes. Stepper motors are present for the positioning of both printheads and movement of filamentous build material. A computer control unit is connected to the outside of the cube support structure.

The extrusion printhead is a direct drive extruder, wherein rollers apply force to filamentous build material. This applied force causes the build material to enter the extrusion printhead and causes heated build material to be extruded through an extrusion nozzle. The internal diameter of the extrusion nozzle is 0.5 mm. The build material is heated at 250-270° C. within the extrusion printhead.

The microheater printhead contains a 1-dimensional array of 2,496 individual heating elements over a distance of 106 mm. The build material is cured by heating elements heated to 950-1050° C. The build material being used in this additive manufacturing system is a filament comprising ceramic particles and polylactic acid polymer. The reservoir of build material is present on a spool, and the build material filament has a diameter of 1.75 mm. After printing, uncured build material is removed by soaking the rough object in hot water containing a surfactant. Removal of uncured build material by agitation using a brush may also be helpful.

### Example 2: An Additive Manufacturing System Using a Metallic Composite Material

A single extrusion printhead and a single microheater printhead are present within an additive manufacturing system. The exterior support structure of the system is in the shape of a cube. The print bed is within the cube at the bottom and is not capable of movement in any axis. The print bed is 220 mm wide and 220 mm deep, with a useable printing area of 200 mm by 200 mm. The print bed is capable of being heated by a closed-loop system using ceramic heating elements. The two printheads are attached to a square-shaped gantry on the interior of the cube. This gantry is capable of vertical movement (movement in the z axis). The z axis height of the microheater printhead, independent of the extrusion printhead, is manually adjustable. Each printhead is capable of movement, independent from the other printhead, along the x and y axes. Each printhead is capable of movement in all 3 axes. Stepper motors are present for the positioning of both printheads and movement of filamentous build material. A computer control unit is connected to the outside of the cube support structure.

The extrusion printhead is a direct drive extruder, wherein rollers apply force to filamentous build material. This applied force causes the build material to enter the extrusion printhead and causes heated build material to be extruded through an extrusion nozzle. The internal diameter of the extrusion nozzle is 0.6 mm. The build material is heated at 200-220° C. within the extrusion printhead.

The microheater printhead contains a 1-dimensional array of 2,496 individual heating elements over a distance of 106 mm. The microheater printhead is moved along two axes for the purpose of extending the area able to be cured by the printhead. The build material is cured by heating elements heated to 750-900° C. The build material being used in this additive manufacturing system is a filament comprising bronze particles and polylactic acid polymer. The reservoir of build material is present on a spool, and the build material filament has a diameter of 1.75 mm. After printing, uncured build material is removed by soaking the rough object in hot water containing a surfactant.

While the foregoing written description enables one of ordinary skill to make and use what is considered presently to be the best mode thereof, those of ordinary skill will understand and appreciate the existence of variations, combinations, and equivalents of the specific embodiments, methods, and examples herein. The disclosure should therefore not be limited by the above-described embodiments, methods, and examples, but by all embodiments and methods within the scope and spirit of the disclosure.

1. A system for additive manufacturing comprising at least one microheater array, at least one extrusion nozzle, and a curable build material, wherein the microheater array comprises at least 20 heating elements.

2. The system of claim 1, wherein the curable build material is a type of clay.

3. The system of any one of claims 1-2, wherein the curable build material comprises particles of clay within a binder, and wherein the binder has a melting temperature below the temperature needed for sintering or curing of the clay particles.

4. The system of claim 1, wherein the curable build material comprises particles of a higher melting temperature polymer present within a polymer of a lower melting temperature.

5. The system of claim 4, wherein the melting temperatures of the two polymers are separated by at least 20 degrees Celsius.

6. The system of claim 4-5, wherein the glass transition temperatures of the two polymers are separated by at least 20 degrees Celsius.

7. The system of claim 1, wherein the curable build material comprises metallic particles within a binder, and wherein the binder has a lower melting temperature than the metallic particles.

8. The system of claim 1, wherein the curable build material comprises at least one of polymer and at least one wax.

9. The system of claim 1, wherein the curable build material comprises particles of an inorganic material within a binder, and wherein the binder has a lower melting temperature than the curing or sintering temperature of the inorganic material.

10. The system of any one of claims 1-9, wherein the microheater array is a linear array.

11. The system of any one of claims 1-9, wherein the microheater array is a 2-dimensional array.

12. The system of any one of claims 1-9, wherein the microheater array is circularly-shaped.

13. The system of any one of claims 1-9, wherein the microheater array is square-shaped rectangularly-shaped.

14. The system of any one of claims 1-13, wherein one microheater array and one extrusion nozzle are present.

15. The system of any one of claims 11-14, wherein the microheater array elements surround the extrusion nozzle.

16. The system of any one of claims 1-15, wherein a build plate moves along 0 axes and at least one printhead moves along 3 axes.

17. The system of any one of claims 1-15, wherein a build plate moves along 1 axis and at least one printhead moves along 2 axes.

18. The system of any one of claims 1-15, wherein a protective sheet is present between the build material and the microheater array.

19. The system of any one of claims 1-18, wherein, as the microheater array cures build material, a vertical offset is present between the heating element surface of the microheater array and the build material.

20. The system of claim 19, wherein the vertical offset is filled with at least one of air, argon, nitrogen, carbon dioxide, an inert gas, a nonflammable gas, and a plasma.

21. The system of any one of claims 1-20, wherein a blade, a doctor blade, a protrusion, or a tool is present to make level extruded build material that has not yet been cured by the thermal printhead.

22. A system for additive manufacturing comprising at least one thermal array, having a plurality of heating elements, and at least one extrusion nozzle.

23. A system for additive manufacturing comprising at least one microheater array and a curable build material, wherein the microheater array comprises at least 20 heating elements.

24. A method of producing a three-dimensional object comprising:
(a) selectively extruding build material through an extrusion nozzle; and
(b) selectively curing build material by heating caused by a heating array.

25. A material for use within an additive manufacturing system comprising a material wherein:
(a) the material is capable of being extruded through an extrusion nozzle at an extrusion temperature; and
(b) the material is capable of being cured through the action of a heating array, and wherein curing takes place at a curing temperature that is higher than the extrusion temperature.

26. The material of claim 25, wherein the material further comprises particles or filaments of a curable build material are present within a surrounding binder material.

27. The material of claim 25, wherein the material further comprises particles or filaments of a polymeric material are present within a binder.
